(19) United States
(12) Patent Application Publication
(10) Pub. No.: US 2011/0126100 A1
(43) Pub. Date: May 26, 2011

(54) METHOD OF PROVIDING GUI FOR GUIDING START POSITION OF USER OPERATION AND DIGITAL DEVICE USING THE SAME

(75) Inventors: Yong-jin SO, Seoul (KR); O-jae Kwon, Seoul (KR); Hyun-ki Kim, Seongnam-si (KR)

(73) Assignee: Samsung Electronics Co., Ltd.

(21) Appl. No.: 12/954,188

(22) Filed: Nov. 24, 2010

(30) Foreign Application Priority Data
Nov. 24, 2009 (KR) 10-2009-0113879
Jan. 27, 2010 (KR) 10-2010-0007372

(51) Int. Cl. G06F 3/01

(52) U.S. Cl. 715/705

(57) ABSTRACT

A method of providing a GUI and a digital device includes determining whether a user has approached a start position of an operation of a user input unit for operating the GUI that is displayed on a display; and displaying a guide on the GUI that is displayed on the display if it is determined that the user has approached the start position of an operation. Accordingly, a user can confirm that his/her finger has approached the start position of an operation through the guide, and thus can input a desired command as seeing only the display.

### PRIORITY

This application claims priority under 35 U.S.C. §119(a) to Korean Patent Application No. 10-2009-0113879, filed on Nov. 24, 2009 and Korean Patent Application No. 10-2010-7372, filed on Jan. 27, 2010, in the Korean Intellectual Property Office, the disclosure of which is incorporated herein by reference.

### BACKGROUND OF THE INVENTION

1.Field of the Invention

The present invention relates generally to a method of providing a Graphic User Interface (GUI) and a digital device using the same, and more particularly to a method of providing a GUI and a digital device using the same, used to input text such as numerals, characters, and the like, and a desired user command.

2.Description of the Related Art

Although digital device capabilities have become diverse, consumers desire small-sized digital devices. With the diversification of digital device functionality and popularization of wireless Internet, users frequently input text, such as numerals, characters, and the like, into the digital device.

Accordingly, convenient keys for inputting characters to the digital device are needed, and providing of such keys in the digital device will allow for a smaller digital device that is desired by the consumers.

There is a need for schemes that enable a user to input text more conveniently and intuitively, keeping the user entertained and the digital device small in size.

### SUMMARY OF THE INVENTION

The present invention has been made to address at least the above problems and/or disadvantages and to provide at least the advantages described below. Accordingly, an aspect of the present invention is to provide a GUI method and digital device which can display a guide on a GUI displayed on a display of the digital device when a user approaches a start position of an operation of a user input unit.

According to one aspect of the present invention, a method of providing a GUI includes determining whether a user has approached a start position of an operation of a user input unit for operating the GUI that is displayed on a display; and displaying a guide on the GUI that is displayed on the display if it is determined that the user has approached the start position.

According to another aspect of the present invention, a digital device includes a display displaying a GUI; a user input unit for operating the GUI that is displayed on the display; a sensor sensing whether a user has approached a start position of an operation of the user input unit; and a control unit displaying a guide on the GUI that is displayed on the display if it is sensed by the sensor that the user has approached the start position.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating an external appearance of a digital device according to an aspect of the present invention;

FIGS. 2A and 2B are diagrams illustrating a process of providing a GUI in a digital device as illustrated in FIG. 1;

FIGS. 3A to 3E are diagrams provided in explaining a numeric input type in which the center of a touchpad is considered as a starting point;

FIGS. 4A to 4C are diagrams illustrating examples of other GUI except for a numeric keypad;

FIG. 5 is a detailed block diagram illustrating the configuration of a digital device as illustrated in FIG. 1;

FIG. 6 is a flowchart provided in explaining a method of providing a GUI according to an embodiment of the present invention;

FIG. 7 is a diagram illustrating an example of an area-item table;

FIGS. 8A and 8B are diagrams illustrating an example of a digital device in which two motion sensors are provided on a touchpad and two guides are provided to be displayed on a display;

FIG. 9 is a diagram illustrating an example of a digital device in which four motion sensors are provided on a touchpad and four guides are provided to be displayed on a display;

FIG. 10 is a diagram illustrating an example of a digital system to which the present invention can be applied; and

FIG. 11 is a diagram illustrating a digital device in which a touchpad is replaced by a hard button pad.

### DETAILED DESCRIPTION OF EMBODIMENTS OF THE PRESENT INVENTION

Hereinafter, embodiments of the present invention are described in detail with reference to the accompanying drawings.

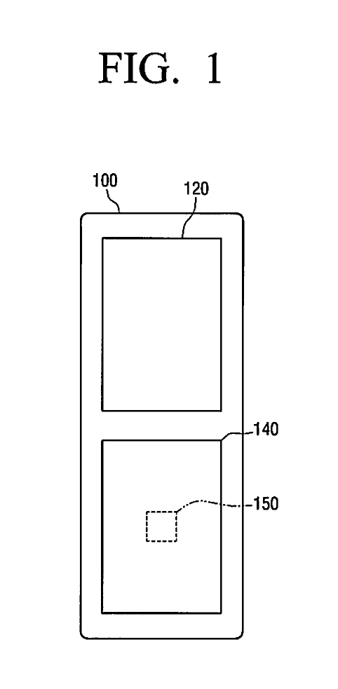

FIG. 1 is a diagram illustrating generally an external appearance of a digital device according to an aspect of the present invention. As illustrated in FIG. 1, a digital device 100 to which the present invention can be applied includes a display 120, a touchpad 140, and a motion sensor 150.

On the display 120, a GUI that is used to input the result of function execution of the digital device 100 and a user command is displayed. The touchpad 140 is a Physical User Interface (PUT) that receives a user operation such as a touch, drag, or the like.

The motion sensor 150 is prepared on a bottom surface of the touchpad 140, and is indicated by a dotted line in FIG. 1. The motion sensor 150 is prepared in the center of the touchpad 140, and senses whether a user finger approaches the center of the touchpad 140.

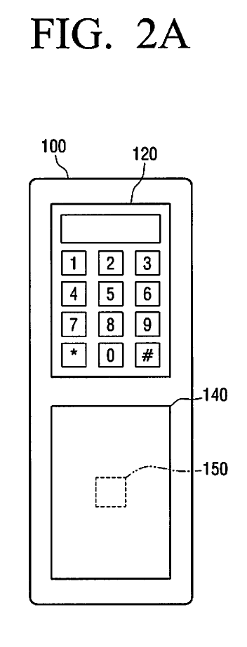

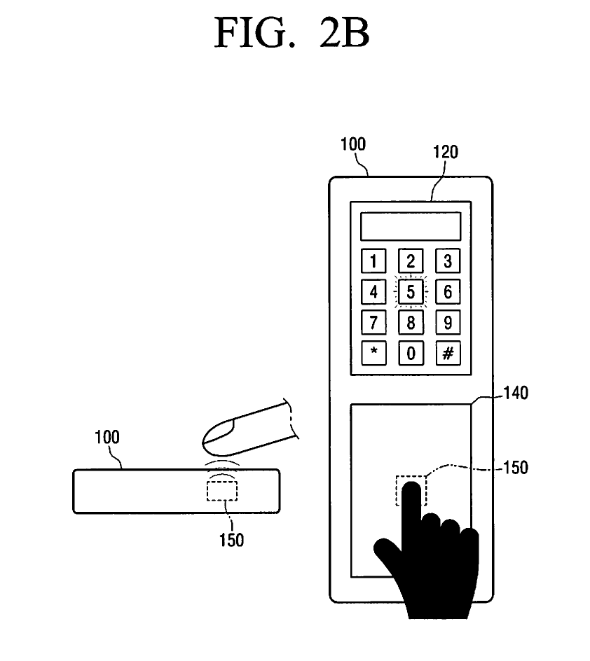

FIGS. 2A and 2B are diagrams illustrating a process of providing a GUI in a digital device 100 as illustrated in FIG. 1.

If a user finger approaches the center of the touchpad 140 as illustrated in FIG. 2B in a state where a numeric keypad is displayed on the display 120 through the GUI as illustrated in FIG. 2A, a guide appears on a “5-number key” among numeric keys displayed on the display 120.

Whether the user finger has approached the center of the touchpad 140 is sensed by the motion sensor 150. The state where the user finger has approached the center of the touchpad 140 is the state where the user finger has not yet touched the touchpad 140 as illustrated on the left side of FIG. 2B.

On the other hand, as illustrated in FIG. 2B, it can be seen that a guide appears on the outline of the “5-number key”. The guide performs a function of guiding that the user finger is positioned in the center of the touchpad 140 which is a starting point in performing a numeric input through a numeric keypad that is displayed on the display 120.

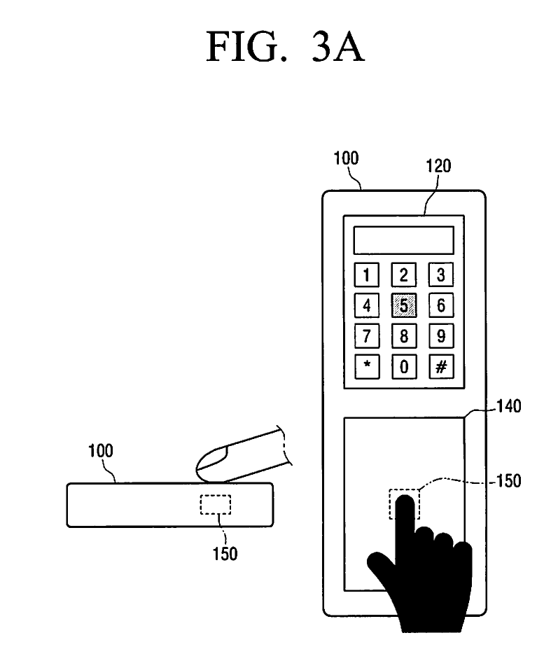

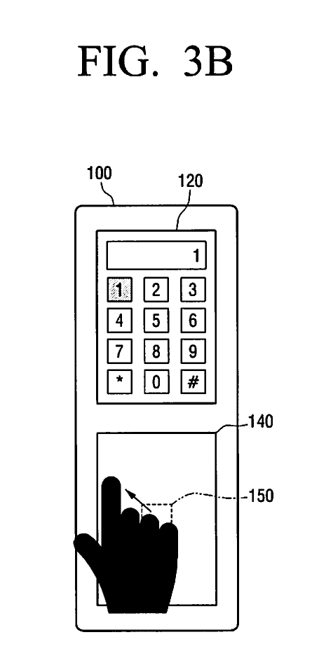

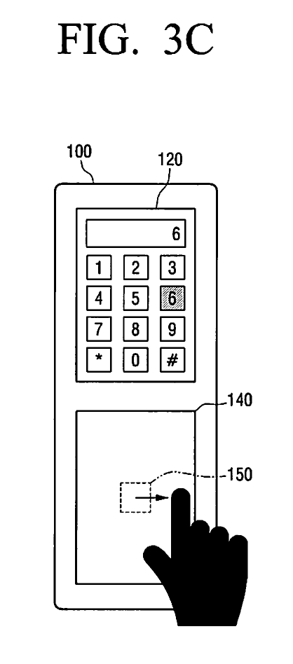

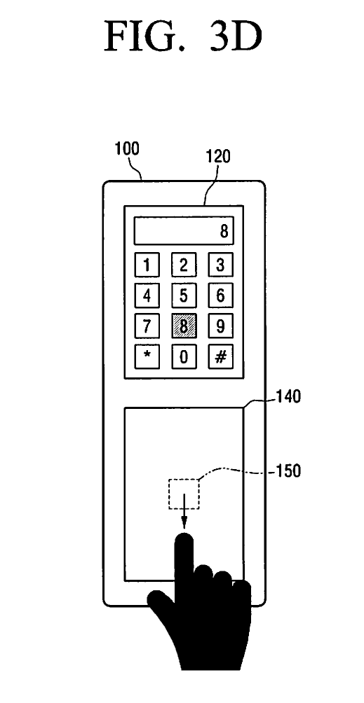

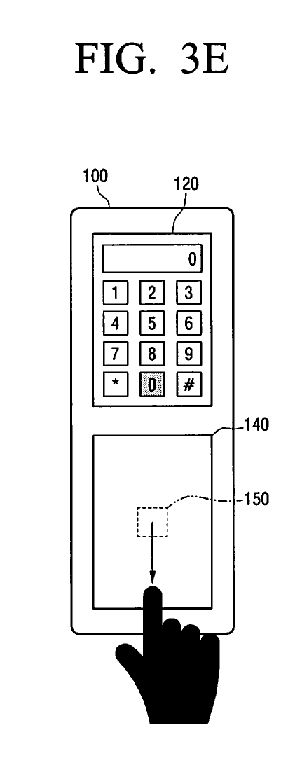

Hereinafter, a method of performing a numeric input in consideration of the center of the touchpad 140 as a starting point will be described in detail with reference to FIGS. 3A to 3E.

If a user touches the touchpad 140 in a state where a guide appears, the “5-number key” is highlighted as illustrated in FIG. 3A.

As described above, the guide appears in the case where the user finger has approached the center of the touchpad 140. Accordingly, when the user has touched the touchpad 140 in a state where the guide appears refers to a user touching the center of the touchpad 140.

If the “5-number key” is highlighted as illustrated in FIG. 3A, the touchpad is in a numeric input standby state. In this state, the user can input a desired numeral by operating the numeric keypad, starting from the “5-number key” as follows.

If the user drags his/her finger from the “5-number key” to a “1-number key” on the touchpad 140 as illustrated in FIG. 3B, the “1-number key” is highlighted, and if the user takes off his/her finger from the touchpad 140, “1” is input and “1” appears on a numeric input window.

If the user drags his/her finger from the “5-number key” to a “6-number key” on the touchpad 140 as illustrated in FIG. 3C, the “6-number key” is highlighted, and if the user takes off his/her finger from the touchpad 140, “6” is input and “6” appears on the numeric input window.

If the user drags his/her finger from the “5-number key” to a “8-number key” on the touchpad 140 as illustrated in FIG. 3D, the “8-number key” is highlighted, and if the user takes off his/her finger from the touchpad 140, “8” is input and “8” appears on the numeric input window.

If the user drags his/her finger from the “5-number key” to a “0-number key” on the touchpad 140 as illustrated in FIG. 3E, the “0-number key” is highlighted, and if the user takes off his/her finger from the touchpad 140, “0” is input and “0” appears on the numeric input window.

On the other hand, although not illustrated in the drawing, if the user touches the center of the touchpad 140 as illustrated in FIG. 3A, and takes off his/her hand from the touchpad 140 in a state where the “5-number key” is highlighted, “5” is input and “5” appears on the numeric input window.

The above-described numeric keypad corresponds to an example of a GUI that can be provided through the display 120. The technical feature of the present invention can be applied to other types of GUI in addition to the numeric keypad.

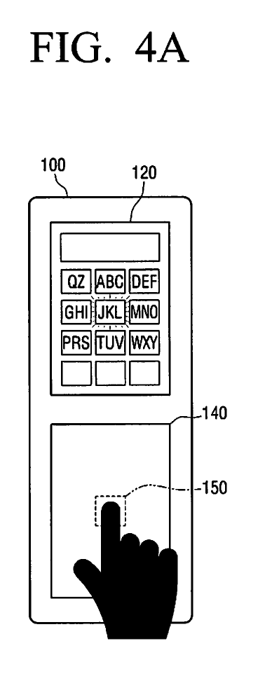

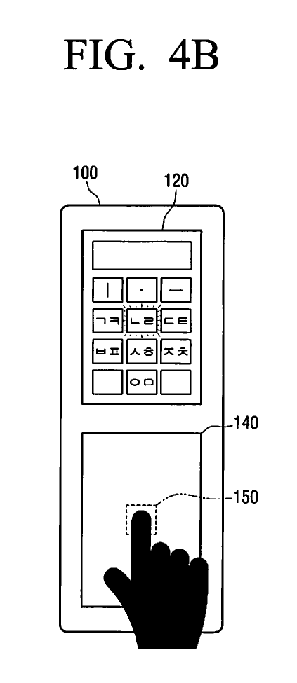

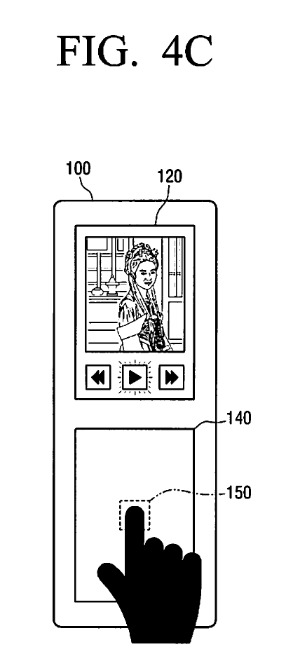

FIG. 4A illustrates an example of an alphabet keypad in which a guide appears on a “JKL-key” in the case where the user finger is positioned in the center of the touchpad 140, and FIG. 4B illustrates an example of a Hangul keypad in which a guide appears on a “L2-key” in the case where the user finger is positioned in the center of the touchpad 140.

On the other hand, the technical feature of the present invention can be applied to another GUI except for the GUI for inputting text such as numerals or characters. An example of another GUI except for the text input is illustrated in FIG. 4C.

FIG. 4C illustrates an example of a graphic controller in which a guide appears on a “ [symbol] -key” in the case where the user finger is positioned in the center of the touchpad 140.

The digital device as illustrated in FIG. 1 can be implemented by various devices. For example, the devices as illustrated in FIG. 1 may implemented by a mobile phone, an MP3 player, a PMP, a mobile computer, a laptop computer, and the like.

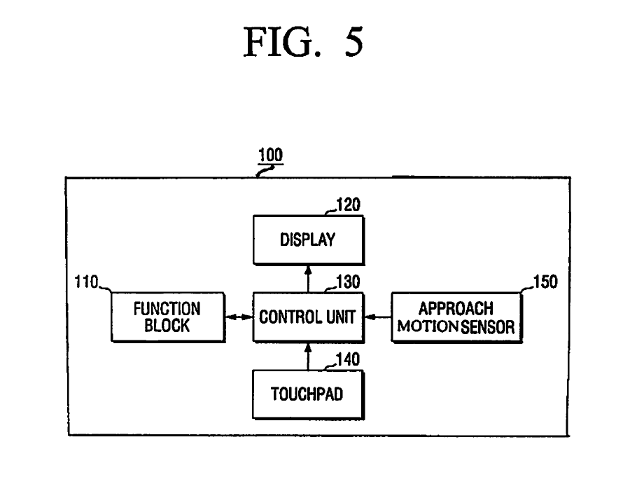

FIG. 5 is a detailed block diagram illustrating the configuration of a digital device as illustrated in FIG. 1. As illustrated in FIG. 5, a digital device 100 includes a function block 110, a display 120, a control unit 130, a touchpad 140, and a motion sensor 150.

The function block 110 performs the original function of the digital device. If the digital device 100 is a mobile phone 10, the function block 110 performs phone call and SMS functions, if the digital device 100 is an MP3 player or a PMP, the function block 110 performs content playback function, and if the digital device is a mobile computer or a laptop computer, the function block 110 performs a task through execution of an application commanded by the user.

On the display 120, the results of performing the function/task of the function block are displayed. The touchpad 140 receives an input of a user operation such as touch, drag, or the like. Also, the motion sensor 150 senses whether the user finger has approached the center of the touchpad 140. The display 120 and/or the pad 140 may be implemented by a touch screen.

The control unit 130 controls the function block 110 so as to perform the function commanded by the user. Also, the control unit 130 provides the GUI to the user through the display 120.

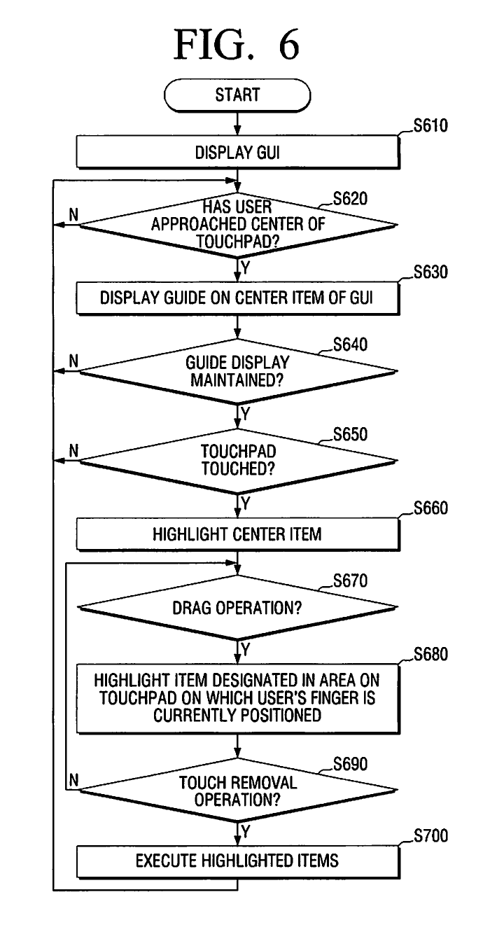

Hereinafter, the process of providing the GUI through the control unit 130 will be described in detail with reference to FIG. 6. FIG. 6 is a flowchart provided in explaining a method of providing a GUI according to an embodiment of the present invention.

As illustrated in FIG. 6, the control unit first displays the GUI on the display 120. The GUI provided in step S610 may be a numeric key keypad as described above, an alphabet keypad, a Hangul keypad, a graphic controller, or the like.

That is, if the GUI includes several items, it can be used in the present invention. Here, the term “item” means an element that can be selected by the user among elements that constitute the GUI. Not only keys, such as the above-described numeric key, an alphabet key, a Hangul key, and a control key, but also an icon or widget are elements that can be selected by the user, and thus they are included in the category of items.

Thereafter, the motion sensor 150 senses whether the user finger has approached the center of the touchpad 140 in step S620.

In step S620, if it is sensed that the user finger has approached the center of the touchpad 140, the control unit 130 displays a guide on the center-item of the GUI in step S630.

The center-item refers to an item that appears in the center of the touchpad 140 among items that constitute the GUI. Here, it should be noted that the center does not mean a physically complete center. That is, if the item that appears in the physically complete center cannot be specified, any one of items that appear in the center portion may be treated as the center-item.

In the same meaning, the center-item may mean a start item in performing a user command input through the items appearing on the GUI.

Thereafter, if the touchpad 140 is touched by the user in step S650 in a state where the guide display on the center-item is maintained in step S640, the control unit 130 highlights the center-item in step S660.

The guide appears when the user finger has approached the center of the touchpad 140. Accordingly, “the case where the touchpad 140 is touched by the user in a state where the guide display on the center-item is maintained” means “the case where the user touches the center of the touchpad 140”.

Thereafter, if the user finger performs the drag operation through the touchpad 140 in step S670, the control unit 130 highlights the item designated on an area on the touchpad 140 on which the user finger is currently positioned in step S680.

In order to perform step S680, the control unit 130 determines the area on the touchpad 140 on which the user finger is currently positioned, and highlights the item designated on the area that is determined with reference to an area-item table.

The area-item table is a table in which “areas on the touchpad 140” and “items appearing on the display 120” match each other in a one-to-one manner, and is defined for each GUI.

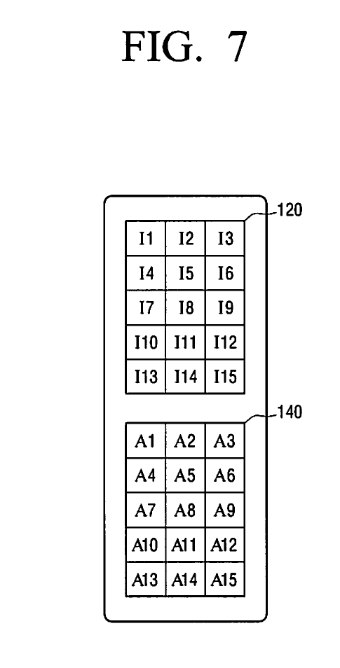

FIG. 7 shows an example of the area-item table. In the case where the area-item table is as illustrated in FIG. 7. If the user finger is positioned at “A1” on the touchpad 140, the control unit 130 highlights the item appearing on “I1” of the display 120. When the user finger is positioned at “A2” on the touchpad 140, the control unit 130 highlights the item appearing on “I2” of the display 120. If the user finger is positioned at “A3” on the touchpad 140, the control unit 130 highlights the item appearing on “I3” of the display 120, and if the user finger is positioned at “A5” on the touchpad 140, the control unit 130 highlights the item appearing on “I15” of the display 120.

Thereafter, if the user finger is removed from the touch in step S690 on the touchpad 140, the control unit 130 executes the highlighted item in step S700.

If the highlighted item is a numeric key, an alphabet key, or a Hangul key, the corresponding text is input, and if the highlighted item is a control key, an icon, or a widget, the corresponding function is executed.

As described above, the digital device 100 is provided with one motion sensor 150 in the center of the touchpad 140. Also, if the user finger approaches the center of the touchpad 140, a guide is displayed on the display 120.

However, two or more motion sensors may be provided on the touchpad 140, and the number of guides that are displayed on the display 120 may be set to be equal to the number of motion sensors.

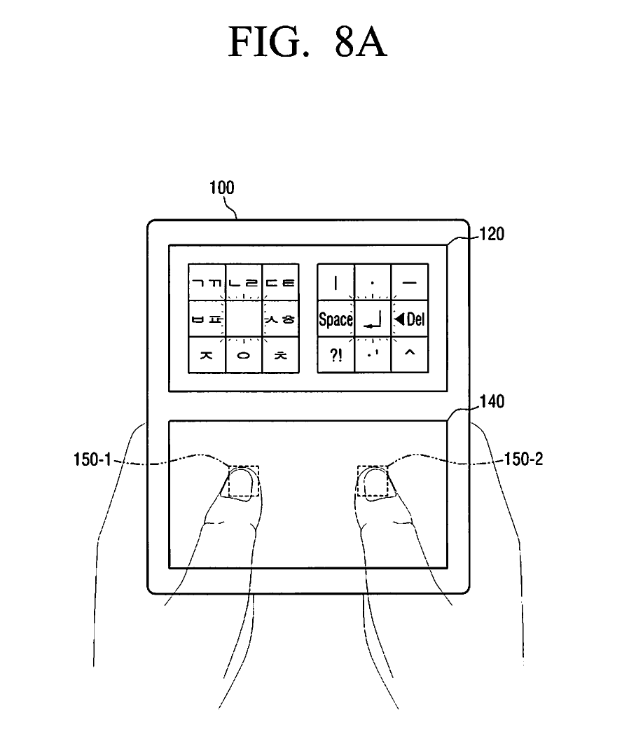

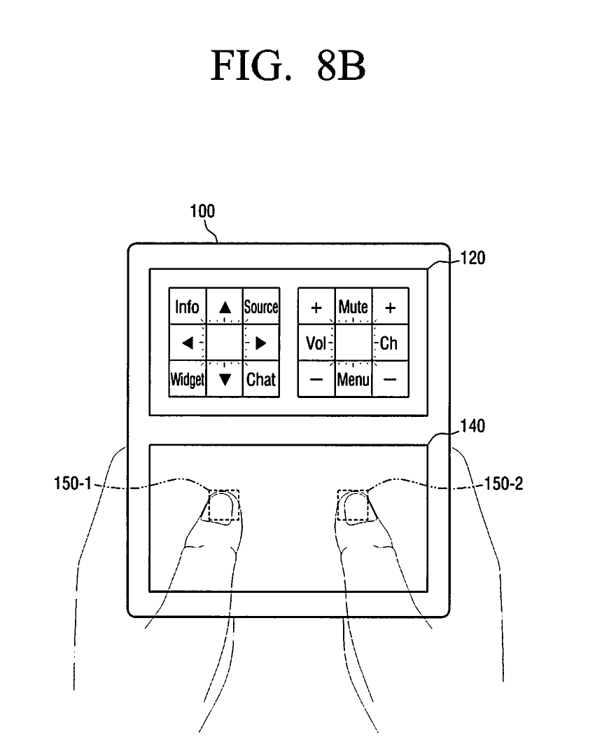

In FIGS. 8A and 8B, two motion sensors 150-1 and 150-2 are provided on the touchpad 140 and two guides are displayed on the display 120. As illustrated, it can be confirmed that the guides appear on the center-item among the first group items appearing on the left of the display 120 and on the center-item among the second group items appearing on the right of the display 120.

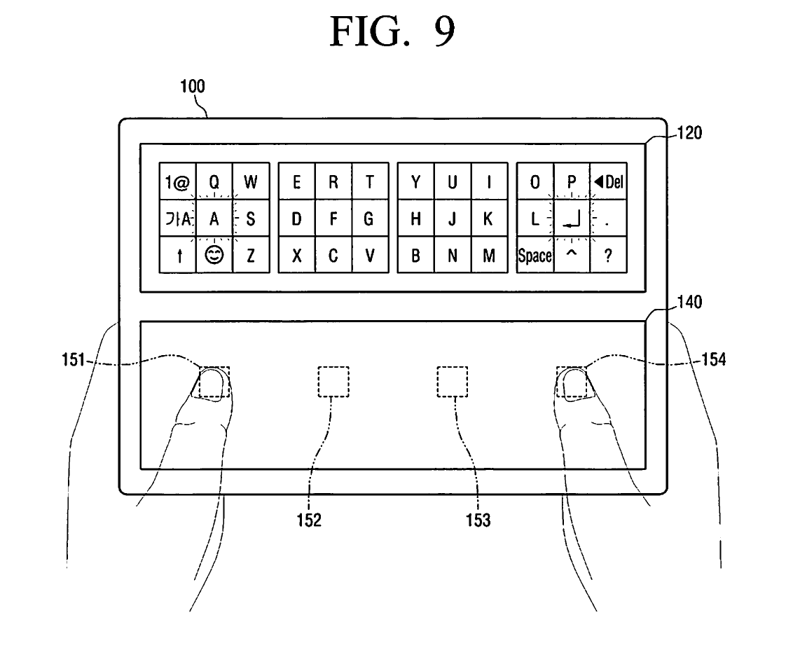

FIG. 9 illustrates four motion sensors 151, 152, 153, and 154 provided on the touchpad 140. Accordingly, the number of guides that can be displayed on the display 120 is four.

In FIG. 9, when the user finger approaches the motion sensor-1 151 and the motion sensor-4 154, the guides appear on the “A” key and the “ENTER” key, which are items designated to the sensors.

If the user finger approaches the motion sensor-2 152 and the motion sensor-3 153, the guides will appear on the “F” key and the “J” key, which are items designated to the sensors.

Up to now, the display 120 and the touchpad 140 are provided in one digital device 100 as an example. However, the display 120 and the touchpad 140 may also be provided in different digital devices, and in this case, the technical features of the invention can be applied to a digital system constructed by digital devices.

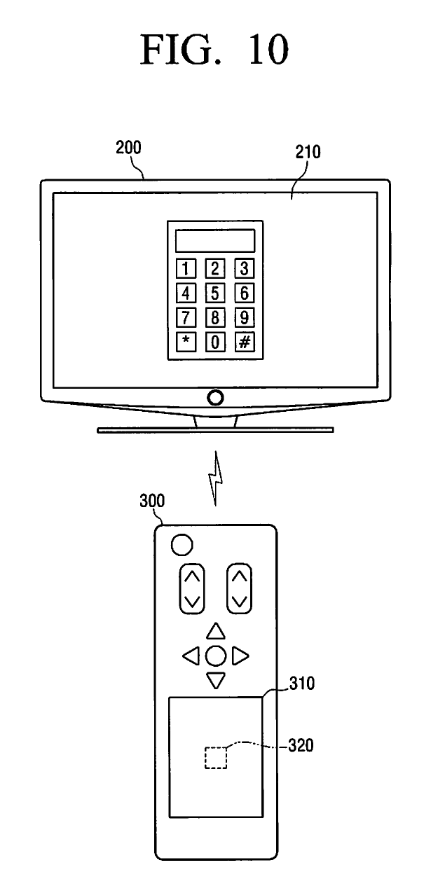

FIG. 10 illustrates a digital system constructed by a DTV 200 provided with a display 210 on which a GUI is displayed, and a remote controller 300 provided with a touchpad 310 on which a motion sensor 320 is positioned.

In the digital system illustrated in FIG. 10, the DTV 200 and the remote controller 300 are communicably connected with each other. The remote controller 300 transfers 1) information on whether the user finger has approached the center of the touchpad 140, and 2) the contents of the user operation (touch, drag, removal of touch, and the like) on the touchpad 140 to the DTV 200. The DTV 200 controls the GUI display state and executes the item based on the information transferred from the remote controller 300.

Accordingly, the display device (for example, DTV 200) according to the above-described embodiment includes a display unit 210, a communication unit (not illustrated), and a control unit (not illustrated)

The display unit 210 displays the GUI. The communication unit (not illustrated) communicates with an external user input device (for example, remote controller 300) for operating the GUI that is displayed on the display unit (not illustrated).

If information on whether the user has approached the operation position of an external user input device 300 is received through the communication unit (not illustrated), the control unit (not illustrated) operates to display the guide that is displayed on the display unit 210 based on the received information.

Also, the user input device (for example, the remote controller 300) according to the above-described embodiment includes a communication unit (not illustrated), a user input unit 310, a sensor unit 320, and a control unit (not illustrated)

The communication unit (not illustrated) communicates with the external display device 200.

The user input unit 310 functions to operate the GUI that is displayed on the external display device 200.

The sensor unit 320 senses whether the user has approached the start position of an operation of the user input unit 310.

If the user approaching motion to the operation position is sensed by the sensor unit 320, the control unit (not illustrated) controls the communication unit (not illustrated) to transit the corresponding information to the external display device 200.

As described above, the touchpad 140 operates as a user command input unit but user input can be achieved through other means as well.

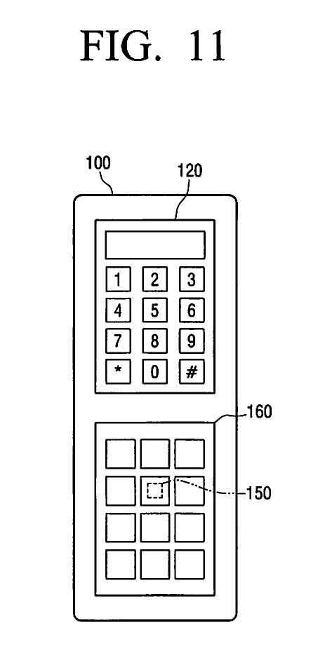

FIG. 11 illustrates a digital device 100 in which a touchpad 140 of the previous figures is replaced by a hard button pad 160. As illustrated in FIG. 11, a motion sensor 150 for sensing whether the user finger has approached the center of the hard button pad 160 is provided on a lower portion of the center button of the hard button pad 160.

If the user is sensed by the motion sensor 150, a guide appears on the “5-number key” among numeric keys appearing on the display 120. The user can perform the numeric input by pressing other buttons based on the hard button having the motion sensor 150 provided on the lower portion thereof.

If the user finger has approached the center of the touchpad 140, a guide appears on the GUI displayed on the display 120, and the center of the touchpad 140 corresponds to the operation start position.

The start position of an operation is a position that should be first operated on the touchpad 140 for the operation for selecting any one of items appearing on the GUI.

The start position of an operation may not necessarily be the center of the touchpad 140, and may be another position on the touchpad 140.

In the above-described examples, the guide is implemented to appear on the outskirts of the item that is selected when the user activates the start position of an operation. It is also possible to make the guide appear inside the item, or to make the guide appear on another position, for example, the center portion of the GUI.

While the invention has been shown and described with reference to certain embodiments thereof, it will be understood by those skilled in the art that various changes in form and detail may be made therein without departing from the spirit and scope of the invention, as defined by the appended claims.

What is claimed is:

1. A method of providing a Graphical User Interface (GUI) comprising:
determining whether a user has approached a start position of an operation of a user input unit for operating the GUI that is displayed on a display; and
displaying a guide on the GUI that is displayed on the display if it is determined that the user has approached the operation start position.

2. The method of providing a GUI as claimed in claim 1, wherein the start position of an operation is a position that should be first operated in the user input unit in order to perform an operation for selecting any one of items appearing on the GUI.

3. The method of providing a GUI as claimed in claim 1, wherein the guide displayed on the GUI is display information for guiding that the user has approached the start position of an operation.

4. The method of providing a GUI as claimed in claim 1, wherein the guide displayed on the GUI appears on at least one of an item that is selected when the user activates the start position of an operation or the outskirts of the item.

5. The method of providing a GUI as claimed in claim 4, wherein the item that is selected when the user activates the start position of an operation is an item that appears in the center portion of the GUI.

6. The method of providing a GUI as claimed in claim 1, wherein the start position of an operation is the center portion of the user input unit.

7. The method of providing a GUI as claimed in claim 6, wherein the guide appears on the center portion of the GUI.

8. The method of providing a GUI as claimed in claim 1, wherein the number of start positions of an operation of the user input unit is plural, and the number of guides displayable in the display step is equal to the number of start positions of an operation.

9. The method of providing a GUI as claimed in claim 8, wherein the start position of an operation includes:
a first start position of an operation that should be first operated in the user input unit in order to perform operation for selecting any one of items of a first group appearing on the GUI; and
a second start position of an operation that should be first operated in the user input unit in order to perform operation for selecting any one of items of a second group appearing on the GUI.

10. The method of providing a GUI as claimed in claim 1, further comprising highlighting any one of items appearing on the GUI if the user touches the user input unit in a state where the guide display is maintained.

11. The method of providing a GUI as claimed in claim 10, further comprising highlighting another one of the items appearing on the GUI based on a dragged area if the user performs a drag operation after touching the user input unit.

12. The method of providing a GUI as claimed in claim 11, further comprising executing the highlighted item if the user removes the touch of the user input unit.

13. The method of providing a GUI as claimed in claim 1, wherein the item is a text key, and
the execution step inputs the text allocated to the highlighted text key.

14. A digital device comprising:
a display unit displaying a Graphical User Interface (GUI);
a user input unit for operating the GUI that is displayed on the display;
a sensor unit sensing whether a user has approached a start position of an operation of the user input unit; and
a control unit displaying a guide on the GUI that is displayed on the display unit if it is sensed by the sensor unit that the user has approached the start position of an operation.

15. The digital device as claimed in claim 14, wherein the start position of an operation is a position that should be first operated in the user input unit in order to perform operation for selecting any one of items appearing on the GUI.

16. The digital device as claimed in claim 14, wherein the guide is display information for guiding that the user has approached the start position of an operation.

17. The digital device as claimed in claim 14, wherein the guide appears on at least one of an item that is selected when the user activates the start position of an operation or the outskirts of the item.

18. The digital device as claimed in claim 14, wherein the start position of an operation is the center portion of the user input unit.

19. The digital device as claimed in claim 18, wherein the guide appears on the center portion of the GUI.

20. The digital device as claimed in claim 14, wherein the number of start positions of an operation of the user input unit is plural, and the number of guides displayable in the display step is equal to the number of start positions.

21. A display device comprising:
a display unit displaying a GUI;
a communication unit communicating with an external user input device for operating the GUI that is displayed on the display unit; and
a control unit displaying a guide on the GUI that is displayed on the display unit based on received information if information on whether a user has approached an operation position of the external user input device is received through the communication unit.

22. A user input device comprising:
a communication unit communicating with an external display device;
a user input unit for operating the GUI that is displayed on the external display device;
a sensor unit sensing whether a user has approached an operation start position of the user input unit; and
a control unit controlling the communication unit to transmit information on whether the user has approached the operation start position to the external display device if it is sensed by the sensor unit that the user has approached the operation start position.
